(19) United States
(12) Patent Application Publication
(10) Pub. No.: US 2026/0007568 A1
(43) Pub. Date: Jan. 8, 2026

(54) SQUEEZING AND SUCTION MASSAGE CUP

(71) Applicant: Shenzhen Imoon Technology Co., Ltd., Shenzhen (CN)

(72) Inventor: Ru Chen, Shenzhen (CN)

(21) Appl. No.: 18/776,147

(22) Filed: Jul. 17, 2024

(30) Foreign Application Priority Data
Jul. 8, 2024 (CN) 202421606775.9

(51) Int. Cl. A61H 19/00; A61H 23/02

(52) U.S. Cl. CPC A61H 19/32; A61H 23/0254; A61H 2201/0153; A61H 2201/1215

(57) ABSTRACT

Disclosed is a squeezing and suction massage cup, including a cup body, a squeezing and suction assembly, a driving motor and a squeezing and suction channel are disposed inside the cup body, where the squeezing and suction assembly includes a transmission member, guide grooves, and squeezing and suction members, the squeezing and suction members are disposed on two sides of the squeezing and suction channel, the transmission member is in transmission connection with the driving motor and the squeezing and suction members, respectively. The present disclosure can effectively enhance the awareness of sexual health of men, relieve sexual pressure and anxiety, provide contraction experience for users and have better function of health care.

This application claims priority of Chinese Patent Application No. 202421606775.9, filed on July 8, 2024, the entire contents of which are incorporated herein by reference.

### TECHNICAL FIELD

The present disclosure relates to the technical field of health care equipment, and specifically relates to a squeezing and suction massage cup.

### BACKGROUND

A massage cup is a portable health care device for men, and is capable of providing health benefits to male sexual organs by using its own health functions. As people’s demands for higher quality sexual experiences continue to grow, more and more massage cups with health massage functions come on the market at present. These massage cups can effectively improve physical and mental health of users, alleviate stress, and improve the quality of life. However, the existing massage cups have relatively limited functionality, and can only reciprocate back and forth, but cannot allow for contraction, therefore, they cannot meet the needs of the users well.

### SUMMARY

In order to solve the problems existing in the prior art, the present disclosure provides a squeezing and suction massage cup, which can effectively enhance the awareness of sexual health of men, relieve sexual pressure and anxiety, provide contraction experience for the men, have better function of health care, improve the quality of life, and meet use demands.

In order to achieve the foregoing object, the present disclosure adopts the following technical solution:

a squeezing and suction massage cup, including a cup body, a squeezing and suction assembly, a driving motor and a squeezing and suction channel are disposed inside the cup body, where the squeezing and suction assembly includes a transmission member, guide grooves and squeezing and suction members, the squeezing and suction members are disposed on two sides of the squeezing and suction channel and are capable of driving the squeezing and suction channel to contract, the transmission member is in transmission connection with the driving motor and the squeezing and suction members, respectively, the driving motor is capable of driving the transmission member to drive the squeezing and suction members to move, one end of each of the squeezing and suction members is mounted inside the guide grooves, and the guide groove can limit activity areas and activity trajectories of the squeezing and suction members.

In the above description, preferably, the transmission member includes a transmission shaft, a positioning bead and a connecting frame, the transmission shaft is in transmission connection with a movable rod of the driving motor, an annular movable groove is formed on an outer wall of the transmission shaft, the annular movable groove is elliptical and obliquely disposed outwards from top to bottom, a sleeve is disposed outside the transmission shaft, the sleeve is connected to the connecting frame, the positioning bead is mounted inside the sleeve through a mounting plate, and a lower end of the positioning bead is abutted against an interior of the movable groove, such that when the transmission shaft rotates, the sleeve is driven to reciprocate back and forth, and the connecting frame is driven to move back and forth at the same time.

In the above description, preferably, a lower end of the mounting plate is provided with a mounting block extending downwards, a mounting hole matched with the positioning bead in size is formed on the mounting block, the positioning bead is snapped into the mounting hole, an opening is formed on an upper end of the sleeve, and the mounting block is inserted into the opening and extends into the sleeve, such that the positioning bead is abutted against the interior of the movable groove.

In the above description, preferably, a lower end of the sleeve is provided with a limiting guide rod, a long limiting groove adapted to the limiting guide rod is formed on an inner wall of the cup body, and the long limiting groove is disposed towards the squeezing and suction channel.

In the above description, preferably, the opening is covered by the mounting plate.

In the above description, preferably, a number of the squeezing and suction members is two, the squeezing and suction members are disposed on the two sides of the squeezing and suction channel, each of the squeezing and suction members includes a connecting portion and a clamping portion, the clamping portion is attached to a side wall of the clamping channel, the connecting portion is provided with a connecting column, a connecting hole adapted to the connecting column is formed on the connecting frame, and the connecting column is inserted into the connecting hole, such that the squeezing and suction members are in transmission connection with the connecting frame.

In the above description, preferably, at least two guide grooves are provided, the two guide grooves are formed on both sides of the transmission member, respectively, the guide grooves are obliquely arranged from outside to inside, a guide rod adapted to the guide grooves is disposed on the connecting portion, and the guide rod is inserted into the guide grooves.

In the above description, preferably, the squeezing and suction massage cup further includes a control assembly, where the control assembly includes a control mainboard, a control button, and a battery power supply, the control button and the battery power supply are both connected to the control mainboard, the control mainboard and the battery power supply are both disposed inside the cup body, and the control button is disposed at an upper end of the cup body.

In the above description, preferably, the opening for making the control button be exposed outwards is formed on an outer wall of the cup body.

In the above description, preferably, a handle is formed at a rear end of the cup body, and the handle is disposed in a ring shape.

The present disclosure has the following beneficial effects: a squeezing and suction assembly, a driving motor and a squeezing and suction channel are disposed inside the cup body, where the squeezing and suction assembly includes a transmission member, guide grooves and squeezing and suction members, the squeezing and suction members are disposed on two sides of the squeezing and suction channel and are capable of driving the squeezing and suction channel to contract, the transmission member is in transmission connection with the driving motor and the squeezing and suction members, respectively, and the driving motor is capable of driving the transmission member to drive the squeezing and suction members to move; and the squeezing and suction members drive the squeezing and suction channel to contract, and the present disclosure can provide contraction experience for the men, have better function of health care, improve the quality of life, effectively enhance the awareness of sexual health of men, relieve sexual pressure and anxiety, and meet use demands.

### BRIEF DESCRIPTION OF THE DRAWINGS

FIG. 1 is a structural schematic diagram of an embodiment according to the present disclosure.

FIG. 2 is a schematic diagram of an internal structure of an embodiment according to the present disclosure.

FIG. 3 is a schematic diagram of a decomposed structure of a contraction state of an embodiment according to the present disclosure.

FIG. 4 is a structural schematic diagram of a squeezing and suction member of an embodiment according to the present disclosure.

FIG. 5 is a structural schematic diagram of a transmission member of an embodiment according to the present disclosure.

Reference numerals in the drawings: 10. cup body; 11. handle; 12. driving motor; 13. long limiting groove; 14. charging interface; 20. transmission member; 21. guide groove; 22. transmission shaft; 23. positioning bead; 24. annular movable groove; 25. sleeve; 251. opening; 26. mounting plate; 27. mounting block; 28. mounting hole; 29. limiting guide rod; 30. squeezing and suction member; 31. connecting portion; 32. clamping portion; 33. connecting column; and 34. guide rod; 40. connecting frame; 41. connecting hole; 50. squeezing and suction channel; 60. battery power supply; and 61. control button.

### DETAILED DESCRIPTIONS OF THE EMBODIMENTS

In order to more clearly illustrate the structural features, technical means, and specific objectives and functions of the present disclosure, the present disclosure will be further described in detail below with reference to the accompanying drawings and specific embodiments.

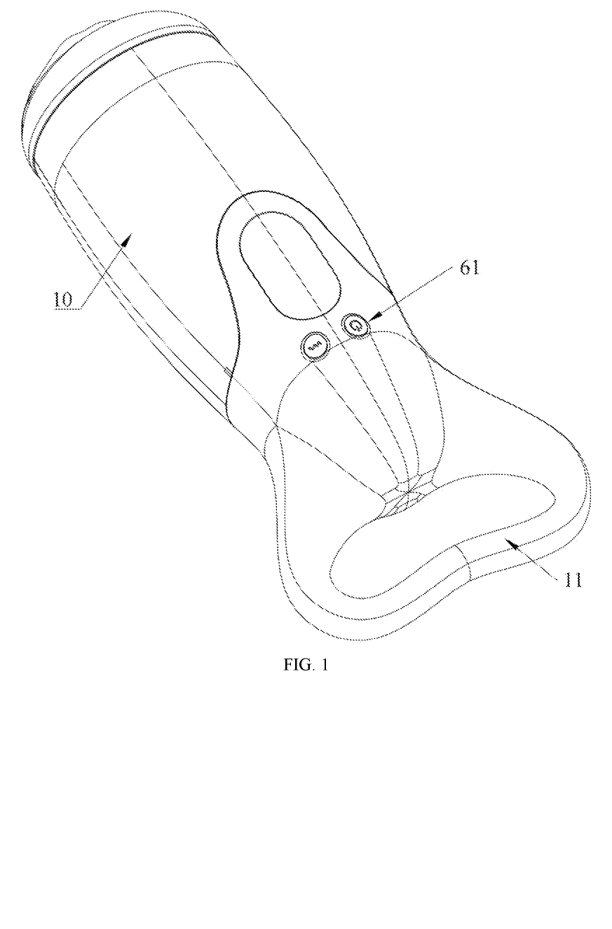

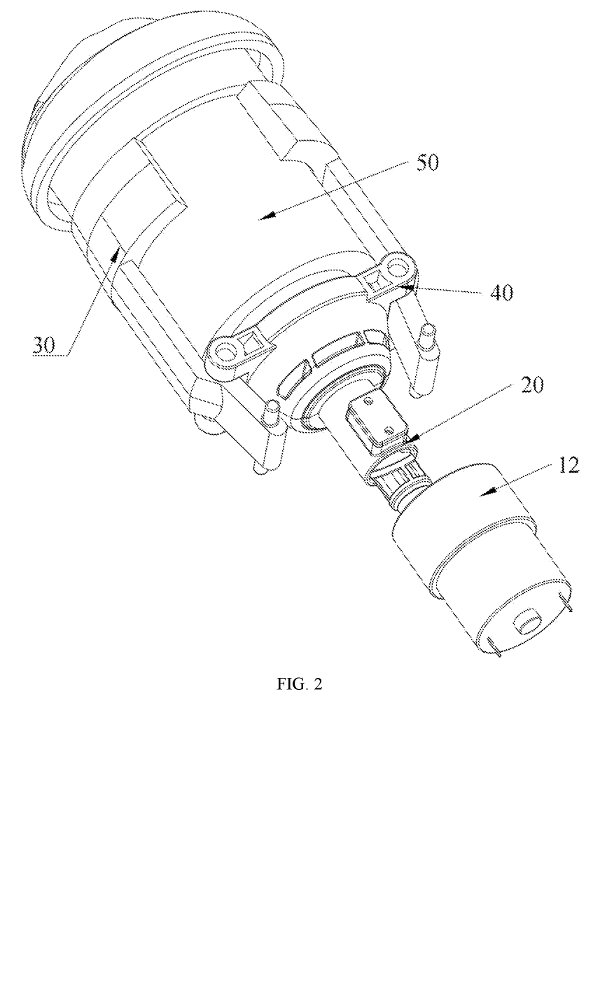

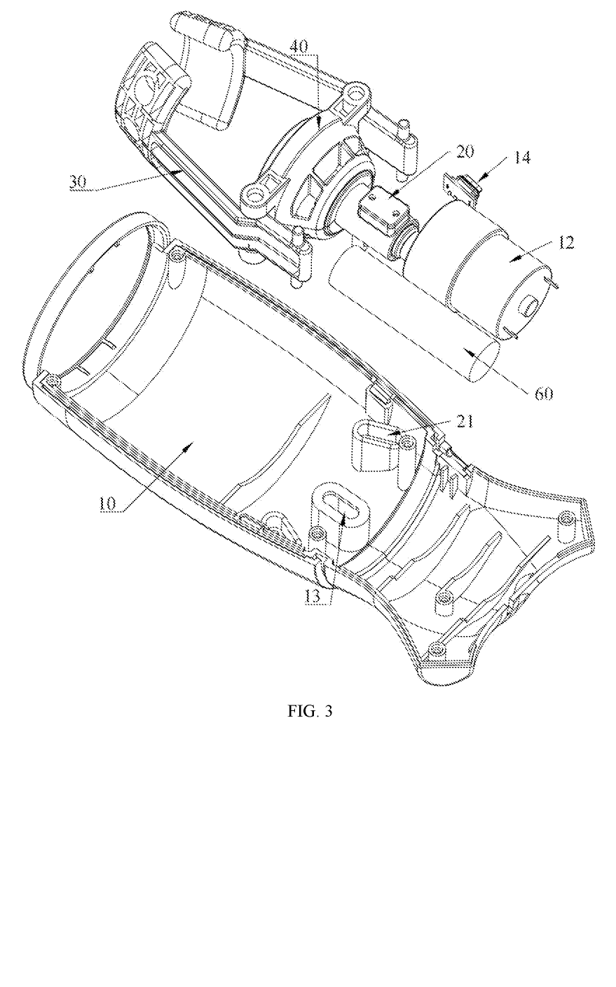

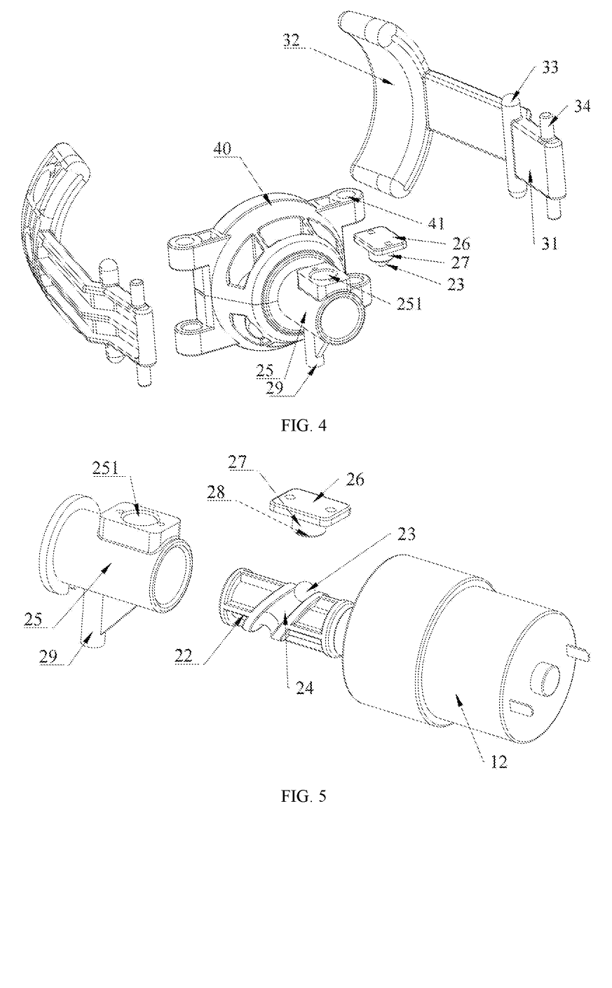

As shown in FIGS. 1-5, this embodiment provides a squeezing and suction massage cup, including a cup body 10, where a handle 11 is formed at a rear end of the cup body 10, and the handle 11 is disposed in a ring shape; and when in use, the handle 11 can be grasped with one hand for operation, making the operation simple and convenient;

a squeezing and suction assembly, a driving motor 12, a squeezing and suction channel 50 and a control assembly are disposed inside the cup body 10, where the driving motor 12 is connected to the control assembly, the control assembly includes a control mainboard, a control button 61 and a battery power supply 60, the control button 61 and the battery power supply 60 are both connected to the control mainboard, the control mainboard and the battery power supply 60 are both disposed inside the cup body 10, the control button 61 is disposed at an upper end of the cup body 10, an opening 251 for making the control button 61 be exposed outwards is formed on an outer wall of the cup body 10, the control button 61 is capable of controlling the turn on and off of the driving motor 12, and a charging interface 14 is formed on a side wall of the cup body 10;

the squeezing and suction assembly includes a transmission member 20, guide grooves 21 and squeezing and suction members 30, where the squeezing and suction members 30 are disposed on two sides of the squeezing and suction channel 50 and are capable of driving the squeezing and suction channel 50 to contract, the transmission member 20 is in transmission connection with the driving motor 12 and the squeezing and suction members 30, respectively, and the driving motor 12 is capable of driving the transmission member 20 to drive the squeezing and suction members 30 to move; the transmission member 20 includes a transmission shaft 22, a positioning bead 23 and a connecting frame 40, the transmission shaft 22 is in transmission connection with a movable rod of the driving motor 12, an annular movable groove 24 is formed on an outer wall of the transmission shaft 22, the annular movable groove 24 is elliptical and obliquely disposed outwards from top to bottom, a sleeve 25 is disposed outside the transmission shaft 22, the sleeve 25 is connected to the connecting frame 40, the positioning bead 23 is mounted inside the sleeve 25 through a mounting plate 26, a lower end of the mounting plate 26 is provided with a mounting block 27 extending downwards, a mounting hole 28 matched with the positioning bead 23 in size is formed on the mounting block 27, the positioning bead 23 is snapped into the mounting hole 28, the opening 251 is covered by the mounting plate 26, the opening 251 is formed on an upper end of the sleeve 25, and the mounting block 27 is inserted into the opening 251 and extends into the sleeve 25, a lower end of the positioning bead 23 is abutted against an interior of the annular movable groove 24, a lower end of the sleeve 25 is provided with a limiting guide rod 29, a long limiting groove 13 adapted to the limiting guide rod 29 is formed on an inner wall of the cup body 10, and the long limiting groove 13 is disposed towards the squeezing and suction channel 50, such that when the transmission shaft 22 rotates, the sleeve 25 is driven to reciprocate back and forth, and the connecting frame 40 is driven to move back and forth at the same time; and

each of the squeezing and suction members 30 includes a connecting portion 31 and a clamping portion 32, the clamping portion 32 is attached to a side wall of the clamping channel 50, the connecting portion 31 is provided with a connecting column 33, a connecting hole 41 adapted to the connecting column 33 is formed on the connecting frame 40, and the connecting column 33 is inserted into the connecting hole 41, such that the squeezing and suction members 30 are in transmission connection with the connecting frame 40; and four guide grooves 21 are provided, the four guide grooves 21 are formed on both sides of an upper end inside the cup body 10 and both sides of a lower end inside the cup body 10, respectively, the guide grooves 21 are obliquely arranged from outside to inside, a guide rod 34 adapted to the guide grooves 21 is disposed on the connecting portion 31, the guide rod 34 is inserted into the guide grooves 21, and when the driving motor 12 drives the transmission shaft 22 to rotate, the positioning bead 23 snapped into the annular movable groove 24 drives the sleeve 25 to move back and forth, and drives the connecting frame 40 to move back and forth at the same time, such that the squeezing and suction member 30 connected to the connecting frame 40 is opened and closed through the guide grooves 21, and the squeezing and suction channel 50 is accordingly driven to contract.

The above description is only preferred embodiments of the present disclosure and is not intended to limit the present disclosure, therefore, any modifications, equivalent replacements, improvements, etc. made to the above embodiments according to the technical solutions of the present disclosure still fall within the scope of the technical solutions of the present disclosure.

1. A squeezing and suction massage cup, comprising a cup body, wherein a squeezing and suction assembly, a driving motor and a squeezing and suction channel are disposed inside the cup body; and the squeezing and suction assembly comprises a transmission member, guide grooves and squeezing and suction members, the squeezing and suction members are disposed on two sides of the squeezing and suction channel and are capable of driving the squeezing and suction channel to contract, the transmission member is in transmission connection with the driving motor and the squeezing and suction members, respectively, the driving motor is capable of driving the transmission member to drive the squeezing and suction members to move, one end of each of the squeezing and suction members is mounted inside the guide grooves, and the guide groove can limit activity areas and activity trajectories of the squeezing and suction members.

2. The squeezing and suction massage cup according to claim 1, wherein the transmission member comprises a transmission shaft, a positioning bead and a connecting frame, the transmission shaft is in transmission connection with a movable rod of the driving motor, an annular movable groove is formed on an outer wall of the transmission shaft, the annular movable groove is elliptical and obliquely disposed outwards from top to bottom, a sleeve is disposed outside the transmission shaft, the sleeve is connected to the connecting frame, the positioning bead is mounted inside the sleeve through a mounting plate, and a lower end of the positioning bead is abutted against an interior of the movable groove, such that when the transmission shaft rotates, the sleeve is driven to reciprocate back and forth, and the connecting frame is driven to move back and forth at the same time.

3. The squeezing and suction massage cup according to claim 2, wherein a lower end of the mounting plate is provided with a mounting block extending downwards, a mounting hole matched with the positioning bead in size is formed on the mounting block, the positioning bead is snapped into the mounting hole, an opening is formed on an upper end of the sleeve, and the mounting block is inserted into the opening and extends into the sleeve, such that the positioning bead is abutted against the interior of the movable groove.

4. The squeezing and suction massage cup according to claim 2, wherein a lower end of the sleeve is provided with a limiting guide rod, a long limiting groove adapted to the limiting guide rod is formed on an inner wall of the cup body, and the long limiting groove is disposed towards the squeezing and suction channel.

5. The squeezing and suction massage cup according to claim 3, wherein the opening is covered by the mounting plate.

6. The squeezing and suction massage cup according to claim 2, wherein a number of the squeezing and suction members is two, the squeezing and suction members are disposed on the two sides of the squeezing and suction channel, each of the squeezing and suction members comprises a connecting portion and a clamping portion, the clamping portion is attached to a side wall of the clamping channel, the connecting portion is provided with a connecting column, a connecting hole adapted to the connecting column is formed on the connecting frame, and the connecting column is inserted into the connecting hole, such that the squeezing and suction members are in transmission connection with the connecting frame.

7. The squeezing and suction massage cup according to claim 6, wherein at least two guide grooves are provided, the two guide grooves are formed on both sides of the transmission member, respectively, the guide grooves are obliquely arranged from outside to inside, a guide rod adapted to the guide grooves is disposed on the connecting portion, and the guide rod is inserted into the guide grooves.

8. The squeezing and suction massage cup according to claim 1, further comprising a control assembly, wherein the control assembly comprises a control mainboard, a control button, and a battery power supply, the control button and the battery power supply are both connected to the control mainboard, the control mainboard and the battery power supply are both disposed inside the cup body, and the control button is disposed at an upper end of the cup body.

9. The squeezing and suction massage cup according to claim 8, wherein the opening for making the control button be exposed outwards is formed on an outer wall of the cup body.

10. The squeezing and suction massage cup according to claim 1, wherein a handle is formed at a rear end of the cup body, and the handle is disposed in a ring shape.
